(19) United States
(12) Patent Application Publication
(10) Pub. No.: US 2020/0241829 A1
(43) Pub. Date: Jul. 30, 2020

(54) METHOD AND SYSTEM FOR CONTROLLING SMART HOME APPLIANCES BY VOICE

(71) Applicant: Foshan Shunde Midea Electrical Heating Appliances Manufacturing Co., Ltd., Foshan (CN)

(72) Inventor: Yongwen LONG, Foshan (CN)

(21) Appl. No.: 16/674,596

(22) Filed: Nov. 5, 2019

(30) Foreign Application Priority Data
Jan. 29, 2019 (CN) 201910085181.5

(51) Int. Cl. G06F 3/16; H04L 12/28

(52) U.S. Cl. CPC G06F 3/16; G10L 2015/223; H04L 12/281

(57) ABSTRACT

A voice control method performed by a first smart home appliance includes receiving voice information, acquiring a control command from the voice information, determining whether the control command is executable by the first smart home appliance, and, in response to determining that the control command is not executable by the first smart home appliance, sending the control command to a second smart home appliance.

### CROSS-REFERENCE TO RELATED APPLICATION

The application claims priority to Chinese Application No. 201910085181.5, filed Jan. 29, 2019, the entire content of which is incorporated herein by reference.

### TECHNICAL FIELD

The present disclosure relates to a field of smart home appliance technology, and particular to method and system for controlling smart home appliances by voice.

### BACKGROUND

With the development of science and technology, home appliances such as a rice cooker, an induction cooker, and a high speed blender are widely applied in daily life, bringing great convenience to users. Nowadays, for some home appliances, a voice interaction between the appliance and the user is realized. The user can understand a real-time working state of a home appliance and make a further control via functions such as voice dialogue, voice inquiry, voice control of the home appliance, which greatly improves the convenience in use. However, there are still many home appliances in the market and in the user's home that do not have a voice interaction device. The user cannot perform voice control during the use process, and still needs to manually operate these existing home appliances, and thus the use process is not intelligent enough which may cause poor user experience.

### SUMMARY

The present disclosure seeks to solve at least one of the problems that exist in the related art to at least some extent.

Accordingly, an object of the present disclosure is to provide a method for controlling smart home appliances by voice. By sending a voice command from a user to a home appliance provided with a voice interaction device, other home appliance that does not have a voice interaction device may be controlled by voice. Further, voice control of a plurality of home appliances can be realized by setting a voice interaction device on only one home appliance, thus reducing cost of the home appliances and making the home appliances more intelligent.

Another object of the present disclosure is to provide a system for controlling smart home appliances by voice.

In order to achieve the above objects, in a first aspect, the present disclosure provides in embodiments a method for controlling smart home appliances by voice, including:

a first smart home appliance receiving voice information and acquiring a first control command from the voice information,

the first smart home appliance determining whether the first control command is executable by the first smart home appliance,

the first smart home appliance sending the first control command to at least one second smart home appliance when it is determined that the first control command is not executable by the first smart home appliance, and

one of the at least one second smart home appliance executing the first control command when the one determines that the first control command is executable by the one of the at least one second smart home appliance.

With the method for controlling smart home appliances according to the first aspect of the present disclosure, by sending the voice command from the user to the home appliance provided with the voice interaction device, other home appliance that does not have the voice interaction device may be controlled by voice. Further, voice control of a plurality of home appliances can be realized by setting the voice interaction device on only one home appliance, thus reducing cost of the home appliances and making the home appliances more intelligent.

In order to achieve the above objects, in a second aspect, the present disclosure provides in embodiments a system for controlling smart home appliances by voice, including:

a first smart home appliance and at least one second home appliance connected to the first smart home appliance electrically, in which

the first smart home appliance is configured to receive voice information, acquire a first control command from the voice information, determine whether the first control command is executable by the first smart home appliance, and send the first control command to at least one second smart home appliance when it is determined that the first control command is not executable by the first smart home appliance, and

the second smart home appliance is configured to execute the first control command when it is determined that the first control command is executable by the second smart home appliance.

With the system for controlling smart home appliances according to the second aspect of the present disclosure, by sending the voice command from the user to the home appliance provided with the voice interaction device, other home appliance that does not have the voice interaction device may be controlled by voice. Further, voice control of a plurality of home appliances can be realized by setting the voice interaction device on only one home appliance, thus reducing cost of the home appliances and making the home appliances more intelligent.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a method for controlling smart home appliances by voice according to an embodiment of the present disclosure;

FIG. 2 is a flow chart of a method for controlling smart home appliances by voice according to another embodiment of the present disclosure;

FIG. 3 is a flow chart of a method for controlling smart home appliances by voice according to still another embodiment of the present disclosure;

FIG. 4 is a flow chart of a method for controlling smart home appliances by voice according to a further embodiment of the present disclosure;

FIG. 5 is a schematic diagram of a system for controlling smart home appliances by voice according to an embodiment of the present disclosure.

### DETAILED DESCRIPTION

Embodiments of the present disclosure are described in detail below, examples of which are illustrated in the drawings. The same or similar elements are denoted by same reference numerals in different drawings unless indicated otherwise. The embodiments described herein with reference to drawings are explanatory, and used to generally understand the present disclosure. The embodiments shall not be construed to limit the present disclosure.

A method and a system for controlling smart home appliances by voice according to embodiments of the present disclosure are described below with reference to the drawings.

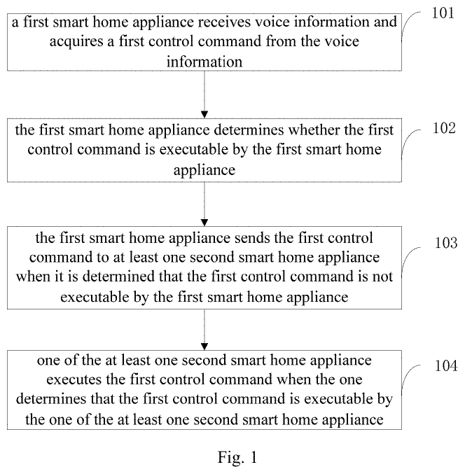

FIG. 1 is a flow chart of a method for controlling smart home appliances by voice according to an embodiment of the present disclosure. As shown in FIG. 1, the method includes following steps.

In block 101, a first smart home appliance receives voice information and acquires a first control command (also referred to as a “to-be-executed control command”) from the voice information.

In the embodiment of the present disclosure, the smart home appliance is provided with a voice interaction device, and the voice information from the user is collected by the voice interaction device. For example, a microphone may be disposed at the smart home appliance, and voice information can be collected through the microphone. For another example, the voice interaction device may also be a microphone array.

Further, in the embodiments of the present disclosure, among a plurality of smart home appliances, a smart home appliance provided with a voice interaction device for collecting voice information from a user is referred to as a first smart home appliance. When multiple smart home appliances are each provided with a voice interaction device, in the embodiments of the present disclosure, one of the multiple smart home appliances may be selected as the first smart home appliance at one time.

As a possible implementation, the first smart home appliance collects the voice information input by the user via the provided voice interaction device (e.g., microphone), and then extracts the first control command from the voice information of the user.

Specifically, the voice information sent by the user needs to carry an operation required to be performed by a smart home appliance to be controlled, for example, cooking or making peanut butter. The voice interaction device of the first smart home appliance is configured to identify the collected voice information, extract the operation to be performed by a smart home appliance, convert the extracted operation into corresponding data, and generate a first control command.

The principle that the voice interaction device converts the voice information into the first control command is as follows.

When the user interacts with the first smart home appliance in voice, the voice interaction device in the first smart home appliance is configured to convert voice information “please help me make peanut butter” from the user into text, and further convert the text into the first control command “command: peanutButter” in a data format. The smart home appliance thus acts according to the control command.

In block 102, the first smart home appliance determines whether the first control command is executable by the first smart home appliance.

In the first smart home appliance, the voice interaction device is connected to the main controller. The first control command is sent from the voice interaction device to the main controller and it is determined by the main controller whether the first control command is executable by the first smart home appliance.

Specifically, the process for the first smart home appliance to determine whether it can execute the first control command is as follows.

The first smart home appliance compares the first control command with its own executable control commands.

When the first control command is one of the executable control commands of the first smart home appliance, it is determined that the first control command is executable by the first smart home appliance.

When the first control command is not one of the executable control commands of the first smart home appliance, it is determined that the first control command is not executable by the first smart home appliance.

Specifically, the main controller of the first smart home appliance stores control commands that can be executed by the first smart home appliance, for example, as a control command list. After receiving the first control command sent by the voice interaction device, the main controller compares the first control command with the at least one executable control command stored therein. If the first control command is one control command in the executable control instruction list, it indicates that the first control command sent from the voice interaction device is executable by the first smart home appliance. If the first control command is not one in the control command list, in this case the first control command sent by the voice interaction device is not executable by the first smart home appliance, that is, the execution target of the voice information provided by the user is not the first smart home appliance.

In block 103, the first smart home appliance sends the first control command to at least one second smart home appliance when it is determined that the first control command is not executable by the first smart home appliance.

In an embodiment of the present disclosure, by determining whether the first control command to be executed is one command in the executable control command list, the first control command is determined to be executed or not by the first smart home appliance. When the first smart home appliance determines that it cannot execute the first control command, the first control command is sent to the second smart home appliance. There may be one or more second smart home appliances. In an embodiment of the present disclosure, the second smart home appliance is not provided with a voice interaction device, and can only receive the first control command that cannot be executed by the first smart home appliance via the wireless connection. Although the second smart home appliance is not provided with the voice interaction device or the voice interaction device of the second smart home appliance is not activated, the voice information input by the user for interaction can still be received, such that the intention of the user for interaction can be responded to. Specifically, the wireless connection may be a 4G or 5G wireless connection, or a Bluetooth wireless connection or a WiFi connection.

As a possible implementation, when the first smart home appliance determines that it cannot execute the first control command, besides sending the first control command to the at least one second mart appliance, the main controller may also generate a reminder message that the first control command is not executed. For example, the first smart home appliance is a rice cooker, and it is determined that it cannot execute the “please help me make peanut butter” command. At this time, a reminder message “workMode: notSupport” is generated in a data format which indicates that the smart home appliance does not support the first control command in the current working state, that is, the first control command cannot be executed. The main controller of the first smart home appliance may return the message “workMode: notSupport” to the voice interaction device. After receiving such a return instruction, the voice interaction device (e.g., including a speaker) is configured to play a voice reminder, for example “Master, I cannot help you make the peanut butter”, which is matched with the message “workMode: notSupport”.

In block 104, one of the at least one second smart home appliance executes the first control command when the one determines that the first control command is executable by the one of the at least one second smart home appliance.

In an embodiment of the present disclosure, after the second smart home appliance receives the first control instruction that cannot be executed by the first smart home appliance, it also needs to determine whether the first control command is executable by the second smart home appliance. The specific process, performed by the second smart home appliance, for determining whether the first control command is executable is similar to that performed by the first smart home appliance, and thus will not be elaborated in detail herein.

When one of the at least one second smart home appliance determines that it can execute the first control command, the one second smart home appliance performs a corresponding action according to the first control command.

Further, when the main controller of the second smart home appliance determines that the second smart home appliance can execute the first control command, on one hand, the main controller controls the second smart home appliance to perform an action corresponding to the first control command, such that the second smart home appliance starts to work according to the voice command of the user; on the other hand, the main controller returns a reminder message, that the first control command is executed, to the first smart home appliance via the wireless connection, which will be described in detail below, and is not be elaborated herein.

In some embodiments, when there are two or more second smart appliances, two or more of them may be the same type of smart appliance or store the same executable control commands. At this time, these smart home appliances may be simultaneously controlled by the voice command of the user. In some embodiments, the control commands in the executable control command databases of these smart home appliances may be numbered, such that the smart home appliances may be controlled separately. In an example, the smart home appliances are high speed blenders of the same model, and the executable first control commands “command: peanutButter” corresponding to the blenders of the same model may be numbered as “command: peanutButter1”, “command: peanutButter2” and the like. A first control command “command: peanutButter1” specific to the high speed blender numbered as No. 1 may be generated when the user gives a voice command “high speed blender No. 1, please help me make peanut butter”.

With the method for controlling smart home appliances according to the embodiment of the present disclosure, by sending the voice command from the user to the home appliance provided with the voice interaction device, other home appliances that do not have the voice interaction device may be controlled by voice. On this basis, voice control of a plurality of home appliances can be realized by setting the voice interaction device on only one home appliance, thus reducing cost of the home appliances and making the home appliances more intelligent.

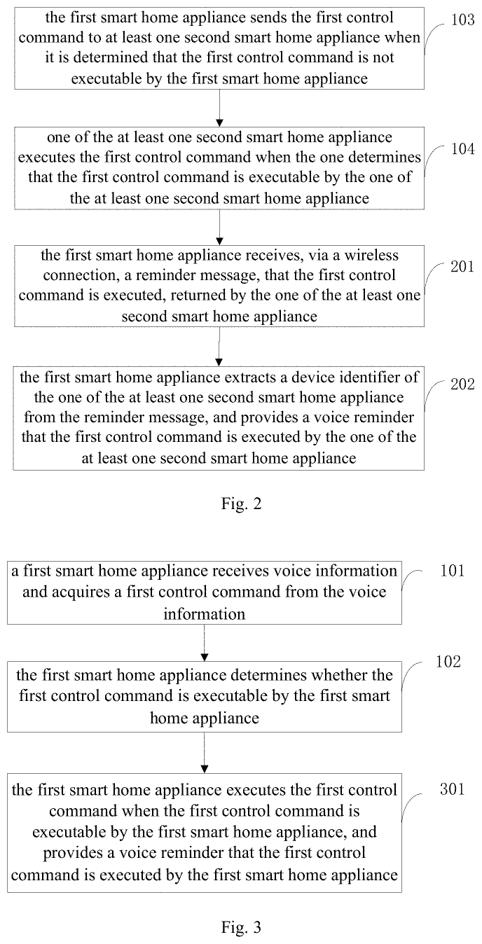

Further, FIG. 2 is a flow chart of a method for controlling smart home appliances by voice according to another embodiment of the present disclosure. After the first smart home appliance determines that the first control command is not executable by the first smart home appliance, the one second smart home appliance determines that it can execute the first control command and execute such a command, as shown in FIG. 2, the method for controlling smart home appliances by voice further includes following steps.

In block 201, the first smart home appliance receives, via a wireless connection, a reminder message, that the first control command is executed, returned by the one of the at least one second smart home appliance.

In block 202, the first smart home appliance extracts a device identifier of the one of the at least one second smart home appliance from the reminder message, and provides a voice reminder that the first control command is executed by the one of the at least one second smart home appliance.

In the embodiment of the present disclosure, there is a wireless connection between the first smart home appliance and the second smart home appliance. For example, it can be a hotspot connection or a Bluetooth connection. Specifically, wireless communication devices are disposed at the first smart home appliance and the second smart home appliance, respectively, and thus the wireless connection between the first smart home appliance and the second smart home appliance is realized by the wireless communication devices.

After the main controller of the second smart home appliance determines that the first control command is executable by such a smart home appliance, a reminder message that the first control command is executed will be returned to the first smart home appliance via the wireless connection. For example, when the first control command is “command: peanutButter”, the reminder message may be “workMode: peanutButter”, which reminds and informs the first smart home appliance about the working state of the second smart home appliance executing the first control command.

Further, in order to let the user explicitly know which home appliance executes the first control command, the reminder message may carry a device identifier of the second smart home appliance that executes the first control command. After the reminder message is received by the wireless communication device in the first smart home appliance, the main controller of the first smart home appliance extract, from the reminder message, the device identifier of the second smart home appliance that executes the first control command. For example, the main controller of the first smart home appliance may store device codes of all smart home appliances in the home, and the device codes may constitute a device code list in which a device code and the name of a corresponding smart home appliance are stored. When the device identifier is acquired, the name of the smart home appliance corresponding to the device identifier may be acquired by searching the device code list.

Further, the main controller is configured to transmit the name of the smart home appliance to the voice interaction device of the first smart home appliance, and the voice interaction device may identify the data command, convert electrical signal into a sound signal, and further broadcast by a speaker arranged in the voice interaction device. For example, the name of the smart home appliance acquired according to the device identifier is “high speed blender”. At this time, the voice “high speed blender has activated the function of peanut butter” is played to remind the user that that the command has been processed, and the corresponding smart home appliance has started to work.

FIG. 3 is a flow chart of a method for controlling smart home appliances by voice according to still another embodiment of the present disclosure. As shown in FIG. 3, after the first smart home appliance determines that the first control command is executable by the first smart home appliance, the method further includes following step.

In block 301, the first smart home appliance executes the first control command when the first control command is executable by the first smart home appliance, and provides a voice reminder that the first control command is executed by the first smart home appliance.

In the embodiment of the present disclosure, when receiving the first control command sent from the voice interaction device, the main controller of the first smart home appliance determines that the first control command is executable by the first smart home appliance by comparing the first control command with the self-executable control commands and further performs an action corresponding to the command. At the same time, the main controller of the first smart home appliance returns a reminder message that the first control command is executed to the voice interaction device, such that a voice player may play the voice reminder accordingly.

Playing the voice by the first smart home appliance to remind the user a current working state of the smart home appliance has been described above, and thus will not be elaborated in detail herein.

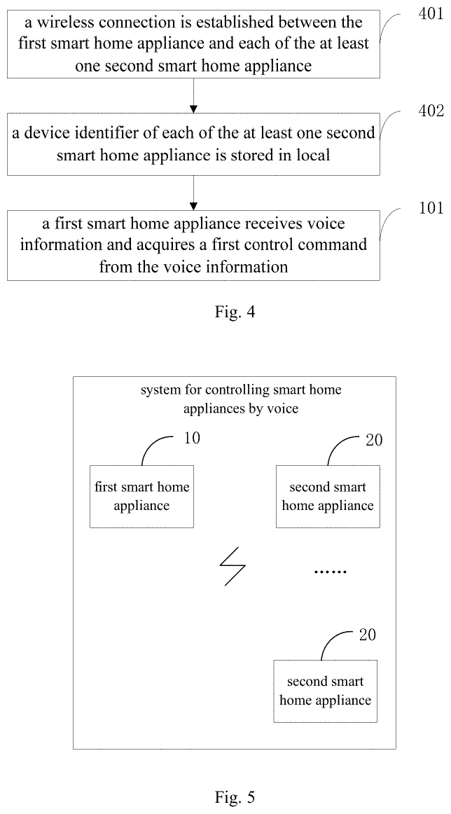

FIG. 4 is a flow chart of a method for controlling smart home appliances by voice according to a further embodiment of the present disclosure.

Specifically, in order to realize the communication between the first smart home appliance and each second smart home appliance, before the first smart home appliance receives the voice information, as shown in FIG. 4, the method further includes following steps.

In block 401, a wireless connection is established between the first smart home appliance and each of the at least one second smart home appliance.

In an embodiment of the present disclosure, the first smart home appliance is connected wirelessly to each of the at least one second smart home appliance by, e.g., Bluetooth, to transmit messages, such as the first control command or the reminder message that the first control command is executed, to each other.

Specifically, the wireless communication devices of the first smart home appliance and the second smart communication may be Bluetooth devices. Specifically, the Bluetooth in the first smart home appliance can be a host device, and the Bluetooth in the second smart home appliance can be a slave device. After the smart home appliances are powered on, the host device starts broadcasting, and the slave device receives the broadcast and sends feedback information to inform the host device that such a second smart home appliance exists, thus pairing the first smart home appliance with the second smart home appliance. After the pairing is successful, a stable channel is established between the two Bluetooth devices, so as to realize sending and receiving data in both-way in time.

Further, the Bluetooth pairing between the first smart home appliance and the second smart home appliance may be realized by using a corresponding APP provided in a mobile phone. Specifically, device names of all the smart home appliances in a smart voice control system can be listed in an interaction interface of the APP. Each device name is linked to its corresponding smart appliance by coupling Bluetooth of the mobile phone with the Bluetooth devices provided in the smart appliance. When the APP is operated by a user, the APP sends a data command to the smart home appliance via the mobile phone Bluetooth, such that precise pairing of two or more smart home appliances may be realized by operating corresponding functions of the APP. It should be noted that the slave device can only be paired with the host device, and the slave devices cannot be paired with each other. If the APP is operated to pair two second smart home appliances, the APP may display “Cannot be paired”. The slave devices may be set in a silent state, such that a communication with a specified host device may be realized.

Further, in actual use, if it is intended to add a smart home appliance provided with a wireless communication device in a system for controlling smart home appliances by voice, the APP can search the smart home appliance database for a device name corresponding to such a smart home appliance, add the device name on the interaction interface of the APP, and link the device name to the corresponding smart home appliance via the mobile phone Bluetooth, so as to facilitate the control of the pairing of the smart home appliance. Similarly, if a smart home appliance in the system is removed or damaged, the device name of the smart home appliance may be removed from the interaction interface of the APP.

In some embodiments, besides the first control command and the reminder message that the first control command is executed, the Bluetooth device may also transmit working state of the smart home appliance to the APP of the mobile phone, and the user can view a current working state of the smart home appliance through the interaction interface of the APP, which is convenient for the user and makes home appliances more intelligent.

In block 402, a device identifier of each of the at least one second smart home appliance is stored locally at the first smart home appliances.

In the embodiment of the present disclosure, the first smart home appliance stores the device identifier of each second smart home appliance locally, e.g., stores Bluetooth address and personal identification number (PIN) of the second smart device.

When it is determined that the first control command is not executable, the first smart home appliance acquires the device identifier of each second smart home appliance, establishes the wireless connection to each second smart home appliance, and simultaneously sends the first control command to each second smart home appliance.

As a possible implementation, the voice information may carry a device name of a second smart home appliance that can execute the first control command, and a device of the second smart home appliance that can execute the first control command may be acquired by searching a mapping relationship between device name and smart home appliance device for the carried device name. On the basis of the device of the second smart home appliance, the first control command may be sent to the second smart home appliance, in which case, there is no need to send the first control command to all the second smart home appliances.

In some embodiments, the first smart home appliance stores device identifiers of all the second smart home appliances. When the voice of the user involves a device name of a second smart home appliance, the voice interaction device converts the device name into a corresponding device identifier, which is further compared with the stored device identifiers. If the device identifier corresponding to the device name exists, it indicates that an object for executing the first control command is a specific and certain one of the second smart home appliances. In this case, the APP may be used to remind the user to pair the first smart home appliance with such a second smart home appliance, or the first smart home appliance may be controlled according to the device identifier, so as to precisely couple the first smart home appliance with the second smart home appliance according to Bluetooth address and PIN of the second smart home appliance corresponding to the device identifier.

In some embodiments, after acquiring the device identifier of the second smart home appliance, the Bluetooth address of the second smart home appliance is queried according to the device identifier, and then the wireless communication device of the first smart home appliance accurately establishes a pairing relationship with the second smart home appliance according to the queried Bluetooth address.

In an example, the voice command from the user is “high speed blender to make peanut butter”, and “high speed blender” is extracted by the voice interaction device, and a device identifier “A” of a second smart home appliance is queried according to the “high speed blender”. Based on the device identifier “A”, the first smart home appliance is connected wirelessly to the second smart home appliance (i.e., the high speed blender) and then sends the first control command to be executed to the high speed blender. With the above possible implementation, there is no need to pair the first smart home appliance with every second smart home appliance, and moreover, the wireless communication device may be powered independently from the smart home appliance, such that it may receive the first control command to realize the turn-on control of the second smart home appliance, thus making the home appliances more intelligent.

In order to realize above embodiments, the present disclosure further provides in embodiments a system for controlling smart home appliances by voice. FIG. 5 is a schematic diagram of a system for controlling smart home appliances by voice according to an embodiment of the present disclosure. As shown in FIG. 5, the system includes a first smart home appliance 10 and at least one second home appliance 20 connected to the first smart home appliance 10. The first smart home appliance 10 is configured to receive voice information, acquire a first control command from the voice information, determine whether the first control command is executable by the first smart home appliance 10, and send the first control command to at least one second smart home appliance 20 when it is determined that the first control command is not executable by the first smart home appliance 10. The second smart home appliance 20 is configured to execute the first control command when it is determined that the first control command is executable by the second smart home appliance 20.

The first smart home appliance 10 is specifically configured to compare the first control command with at least one executable control command of the first smart home appliance 10, determine that the first control command is executable by the first smart home appliance 10 when the first control command is one of the at least one executable control command of the first smart home appliance 10, determine that the first control command is not executable by the first smart home appliance 10 when the first control command is not one of the at least one executable control command of the first smart home appliance 10. In some embodiments, the second smart home appliance 20 is specifically configured to: compare the first control command with at least one executable control command of the second smart home appliance 20, determine that the first control command is executable by the second smart home appliance 20 when the first control command is one of the at least one executable control command of the second smart home appliance 20, determine that the first control command is not executable by the second smart home appliance 20 when the first control command is not one of the at least one executable control command of the second smart home appliance 20.

Specifically, the first smart home appliance 10 is further configured to execute the first control command when the first control command is executable by the first home appliance, and provide a voice reminder that the first control command is executed by the first smart home appliance 10.

Specifically, the first smart home appliance 10 is further configured to, after the first control command is executed by one of the at least one second smart home appliance 20, receive, via a wireless connection, a reminder message, that the first control command is executed, returned by the one of the at least one second smart home appliance 20, extract a device identifier of the one of the at least one second smart home appliance 20 from the reminder message, and provide a voice reminder that the first control command is executed by the one of the at least one second smart home appliance 20.

Specifically, the first smart home appliance 10 is further configured to, before the first smart home appliance 10 receives the voice information, establish a wireless connection to each of the at least one second smart home appliance 20, and store a device identifier of each of the at least one second smart home appliance 20 in local.

Specifically, the first smart home appliance 10 is further configured to send the first control command to the at least one second smart home appliance 20 via the wireless connection.

Specifically, the first smart home appliance 10 is further configured to acquire a device identifier of the second smart home appliance 20, and send the first control command to the second smart home appliance 20 via the wireless connection according to the device identifier.

With the system for controlling smart home appliances according to the embodiments of the present disclosure, by sending the voice command from the user to the home appliance provided with the voice interaction device, other home appliance that does not have the voice interaction device may be controlled by voice. Further, voice control of a plurality of home appliances can be realized by setting the voice interaction device on only one home appliance, thus reducing cost of the home appliances and making the home appliances more intelligent.

In the specification, it is to be understood that terms such as “central”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial” and “circumferential” should be construed to refer to the orientation as then described or as shown in the drawings under discussion. These relative terms are for convenience of description and do not require that the present disclosure be constructed or operated in a particular orientation, and thus shall not be construed to limit the present disclosure.

In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, unless specified otherwise, “a plurality of” means two or more than two.

In the present disclosure, unless specified or limited otherwise, the terms “mounted”, “connected”, “coupled”, “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the description, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. Thus, the appearances of above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples described in the specification, as well as features of embodiments or examples, without conflicting, may be combined by one skilled in the art.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A voice control method comprising:
receiving, by a first smart home appliance, voice information;
acquiring a control command from the voice information;
determining whether the control command is executable by the first smart home appliance; and
in response to determining that the control command is not executable by the first smart home appliance, sending the control command to a second smart home appliance.

2. The method according to claim 1, wherein determining whether the control command is executable by the first smart home appliance comprises:
comparing the control command with at least one executable control command of the first smart home appliance;
determining that the control command is executable by the first smart home appliance in response to determining that the control command is one of the at least one executable control command of the first smart home appliance; and
determining that the control command is not executable by the first smart home appliance in response to determining that the control command is not one of the at least one executable control command of the first smart home appliance.

3. The method according to claim 1, further comprising, in response to determining that the control command is executable by the first smart home appliance:
executing the control command; and
providing a voice reminder that the control command is executed by the first smart home appliance.

4. The method according to claim 1, further comprising:
receiving, via a wireless connection, a reminder message returned by the second smart home appliance, the reminder message indicating that the control command is executed;
extracting a device identifier of the second smart home appliance from the reminder message; and
providing a voice reminder that the control command is executed by the second smart home appliance.

5. The method according to claim 1, further comprising, before sending the control command to the second smart home appliance:
establishing a wireless connection between the first smart home appliance and the second smart home appliance; and
storing a device identifier of the second smart home appliance locally in the first smart home appliance.

6. The method according to claim 5, wherein sending the control command to the second smart home appliance comprises:
sending the control command to the second smart home appliance via the wireless connection.

7. The method according to claim 6, wherein sending the control command to the second smart home appliance via the wireless connection comprises:
acquiring a device identifier of the second smart home appliance; and
sending the control command to the second smart home appliance via the wireless connection according to the device identifier.

8. A smart home appliance comprising:
a voice interaction device configured to collect voice information; and
a controller coupled to the voice interaction device and configured to:
acquire a control command from the voice information;
determine whether the control command is executable by the smart home appliance; and
in response to determining that the control command is not executable by the smart home appliance, send the control command to another smart home appliance.

9. The smart home appliance according to claim 8, wherein the controller is further configured to determine whether the control command is executable by the smart home appliance by:
comparing the control command with at least one executable control command of the smart home appliance;
determining that the control command is executable by the smart home appliance in response to determining that the control command is one of the at least one executable control command of the smart home appliance; and
determining that the control command is not executable by the first smart home appliance in response to determining that the control command is not one of the at least one executable control command of the first smart home appliance.

10. The smart home appliance according to claim 8, wherein the controller is further configured to, in response to determining that the control command is executable by the smart home appliance:
control the smart home appliance to execute the control command; and
control the voice interaction device to provide a voice reminder that the control command is executed by the smart home appliance.

11. The smart home appliance according to claim 8, wherein the controller is further configured to:
receive, via a wireless connection, a reminder message returned by the another smart home appliance, the reminder message indicating that the control command is executed;
extract a device identifier of the another smart home appliance from the reminder message; and
control the voice interaction device to provide a voice reminder that the control command is executed by the another smart home appliance.

12. The smart home appliance according to claim 8, wherein the controller is further configured to, before sending the control command to the another smart home appliance:
establish a wireless connection between the smart home appliance and the another smart home appliance; and
store a device identifier of the another smart home appliance locally in the smart home appliance.

13. A voice control system comprising:
a first smart home appliance; and
a second smart home appliance connected to the first smart home appliance;
wherein the first smart home appliance is configured to:
receive voice information;
acquire a control command from the voice information;
determine whether the control command is executable by the first smart home appliance; and
in response to determining that the control command is not executable by the first smart home appliance, send the control command to the second smart home appliance; and
wherein the second smart home appliance is configured to:
determine whether the control command is executable by the second smart home appliance; and
in response to determining that the control command is executable by the second smart home appliance, execute the control command.

14. The system according to claim 13, wherein the first smart home appliance is further configured to:
compare the control command with at least one executable control command of the first smart home appliance;
determine that the control command is executable by the first smart home appliance in response to determining that the control command is one of the at least one executable control command of the first smart home appliance; and
determine that the control command is not executable by the first smart home appliance in response to determining that the control command is not one of the at least one executable control command of the first smart home appliance.

15. The system according to claim 13, wherein the second smart home appliance is further configured to:
compare the control command with at least one executable control command of the second smart home appliance;
determine that the control command is executable by the second smart home appliance in response to determining that the control command is one of the at least one executable control command of the second smart home appliance; and
determine that the control command is not executable by the second smart home appliance in response to determining that the control command is not one of the at least one executable control command of the second smart home appliance.

16. The system according to claim 13, wherein the first smart home appliance is further configured to, in response to determining that the control command is executable by the smart home appliance:
execute the control command; and
provide a voice reminder that the control command is executed by the first smart home appliance.

17. The system according to claim 13, wherein the first smart home appliance is further configured to:
receive, via a wireless connection, a reminder message returned by the second smart home appliance, the reminder message indicating that the control command is executed;
extract a device identifier of the second smart home appliance from the reminder message; and
provide a voice reminder that the control command is executed by the second smart home appliance.

18. The system according to claim 13, wherein the first smart home appliance is further configured to, before sending the control command to the second smart home appliance:
establish a wireless connection to the second smart home appliance; and
store a device identifier of the second smart home appliance locally in the first smart home appliance.

19. The system according to claim 18, wherein the first smart home appliance is further configured to:
send the control command to the second smart home appliance via the wireless connection.

20. The system according to claim 19, wherein the first smart home appliance is further configured to:
acquire a device identifier of the second smart home appliance; and
send the control command to the second smart home appliance via the wireless connection according to the device identifier.
